(19) United States
(12) Patent Application Publication
(10) Pub. No.: US 2024/0430546 A1
(43) Pub. Date: Dec. 26, 2024

(54) INFORMATION PROCESSING APPARATUS, IMAGE CAPTURING APPARATUS, AND CONTROL METHOD

(71) Applicant: CANON KABUSHIKI KAISHA, Tokyo (JP)

(72) Inventor: YUICHI HIRAI, Tokyo (JP)

(21) Appl. No.: 18/743,584

(22) Filed: Jun. 14, 2024

(30) Foreign Application Priority Data
Jun. 26, 2023 (JP) 2023-104503

(51) Int. Cl. H04N 23/11; H04N 23/21; H04N 23/73

(52) U.S. Cl. CPC H04N 23/11; H04N 23/21; H04N 23/73

(57) ABSTRACT

An apparatus determines exposure settings of an imaging apparatus that shoots a subject in relation to light of two types of wavelength ranges. The apparatus obtains a result of photometering in relation to light of a first wavelength range and light of a second wavelength range, determines, based on the result of photometering for the first wavelength range, first exposure settings for shooting in relation to the first wavelength range, and determines, based on the result of photometering for the second wavelength range and on the first exposure settings, second exposure settings for shooting in relation to the second wavelength range. The settings include a diaphragm value, and the apparatus determines a second diaphragm value for the second exposure settings, the second diaphragm value achieving a larger aperture than a first diaphragm value for the first exposure settings.

### BACKGROUND

### Field

The present disclosure relates to an information processing apparatus, an image capturing apparatus, and a control method, and in particular to a technique to shoot visible light images and near-infrared light images of a subject.

### Description of the Related Art

In the field of machine vision that is used in factory automation and the like, near-infrared light images are shot, in addition to visible light images, and used to grasp a state of a subject. As near-infrared light has the property that makes it easily transmitted through a material, a near-infrared light image can be utilized in, for example, determination of the freshness of agricultural products, detection of foreign substances mixed in food, and detection of defects in industrial products. On the other hand, a visible light image allows information of accurate shapes and colors to be obtained; thus, various states of a subject can be detected/determined by combining these images. Therefore, in the field of machine vision, there are case examples in which an image capturing apparatus capable of shooting visible light images and near-infrared light images is adopted.

Meanwhile, visible light and near-infrared light are different in terms of axial chromatic aberration, which occurs via an optical system. Therefore, in a case where shooting has been performed in a state where focus has been achieved based on visible light, the depth of field and the in-focus state (focus position) of a subject in a visible light image may deviate from those in a near-infrared light image. If such a deviation occurs between the visible light image and the near-infrared light image, for example, the reliability degree of an inspection that uses a group of these images decreases. In view of this, Japanese Patent Laid-Open No. 2022-011575 discloses an image capturing apparatus that composites together a visible light image and a near-infrared light image in a mode in which the difference between the in-focus states of the respective images can be confirmed, and displays the composite image.

However, the cause of the difference between the in-focus states appearing in the visible light image and the near-infrared light image is not limited to axial chromatic aberration that occurs via an optical system. Diffraction, which occurs via a diaphragm, can also be the cause. Regarding a visible light image and a near-infrared light image that have been shot under the same diaphragm value, the latter image appears to be low in resolution because the near-infrared light, which has long wavelengths, spreads wider due to the influence of diffraction when an image thereof is formed on an image sensor.

### SUMMARY

The present disclosure has been made in view of the foregoing problem, and provides an information processing apparatus, an image capturing apparatus, and a control method that determine exposure settings for obtaining a visible light image and a near-infrared light image that exhibit a small deviation from each other in terms of apparent resolution.

The present disclosure in its first aspect provides an information processing apparatus that determines exposure settings of an image capturing apparatus that shoots a subject in relation to light of two types of wavelength ranges, the information processing apparatus comprising: at least one processor or circuit configured to function as a first obtainment unit configured to obtain a result of photometering for the subject in relation to each of light of a first wavelength range and light of a second wavelength range that includes longer wavelengths than the first wavelength range, a first determination unit configured to, based on the result of photometering for the light of the first wavelength range, determine first exposure settings for shooting the subject in relation to the light of the first wavelength range, and a second determination unit configured to, based on the result of photometering for the light of the second wavelength range and on the first exposure settings, determine second exposure settings for shooting the subject in relation to the light of the second wavelength range, wherein the exposure settings include a diaphragm value, and the second determination unit determines a second diaphragm value for the second exposure settings, the second diaphragm value achieving a larger aperture than a first diaphragm value determined by the first determination unit.

The present disclosure in its second aspect provides an image capturing apparatus, comprising: the information processing apparatus according to the first aspect; a first image capturing device configured to shoot the subject in relation to the light of the first wavelength range; a second image capturing device configured to shoot the subject in relation to the light of the second wavelength range; and at least one processor or circuit configured to function as a control unit configured to cause the first image capturing device to shoot the subject based on the first exposure settings determined by the first determination unit, and cause the second image capturing device to shoot the subject based on the second exposure settings determined by the second determination unit.

The present disclosure in its third aspect provides a control method for an information processing apparatus that determines exposure settings of an image capturing apparatus that shoots a subject in relation to light of two types of wavelength ranges, the control method comprising: obtaining a result of photometering for the subject in relation to each of light of a first wavelength range and light of a second wavelength range that includes longer wavelengths than the first wavelength range; based on the result of photometering for the light of the first wavelength range, determining first exposure settings for shooting the subject in relation to the light of the first wavelength range; and based on the result of photometering for the light of the second wavelength range and on the first exposure settings, determining second exposure settings for shooting the subject in relation to the light of the second wavelength range, wherein the exposure settings include a diaphragm value, and a second diaphragm that achieves a larger aperture than a first diaphragm value determined for the first exposure settings is determined for the second exposure settings.

Further features of the present invention will become apparent from the following description of exemplary embodiments (with reference to the attached drawings).

### BRIEF DESCRIPTION OF THE DRAWINGS

FIG. 1 is a block diagram exemplarily showing a configuration of an image capturing apparatus 100 according to a first embodiment.

FIGS. 2A and 2B are diagrams for the explanation of an image capturing unit 304 according to the first embodiment.

FIGS. 3A, 3B, and 3C are diagrams exemplarily showing the correspondence relationships between a Tv value and a shutter speed, between an Av value and a diaphragm value, and between an ISO sensitivity and a correction stop of an Ev value according to each embodiment and modification example.

FIG. 4 is a diagram exemplarily showing a relationship among discrete parameters of exposure settings according to each embodiment and modification example.

FIG. 5 is a diagram exemplarily showing Airy disk diameters according to each embodiment and modification example, which respectively correspond to diaphragm values, on a per-wavelength basis.

FIG. 6 is a flowchart exemplarily showing shooting processing executed by the image capturing apparatus 100 according to the first embodiment.

FIGS. 7A and 7B are flowcharts exemplarily showing determination processing executed by the image capturing apparatus 100 according to the first embodiment.

FIG. 8 is a block diagram exemplarily showing a configuration of the image capturing apparatus 100 according to a third modification example and a second embodiment.

FIGS. 9A and 9B are diagrams illustrating the spectral sensitivity properties of an image capturing unit 801 and an image capturing unit 802 according to the third modification example and the second embodiment.

FIG. 10 is a flowchart exemplarily showing shooting processing executed by the image capturing apparatus 100 according to the second embodiment.

FIGS. 11A and 11B are flowcharts exemplarily showing determination processing executed by the image capturing apparatus 100 according to the second embodiment.

FIGS. 12A and 12B are diagrams exemplarily showing the spectral properties of light emitting elements according to a fourth modification example.

### DESCRIPTION OF THE EMBODIMENTS

### First Embodiment

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

An embodiment described below is an example in which the present disclosure is applied to an image capturing apparatus that is capable of capturing images of visible light and near-infrared light as one example of an information processing apparatus. However, the present disclosure is applicable to any device that can determine, for an image capturing apparatus capable of capturing images of a subject in relation to light of two types of wavelength ranges, exposure settings to be configured at the time of capturing of each image.

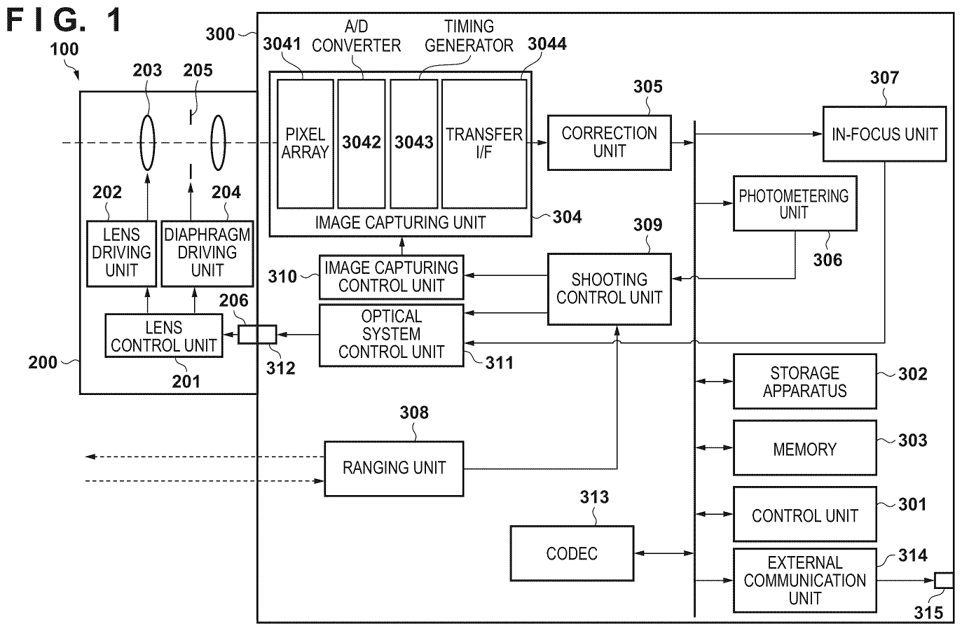

FIG. 1 is a block diagram showing a functional configuration of an image capturing apparatus 100 according to an embodiment of the present disclosure. In the present embodiment, the image capturing apparatus 100 will be described to be an interchangeable-lens type and composed of a lens barrel 200 and a body unit 300.

The lens barrel 200 is an image capturing optical system configured to allow wavelengths in a visible light range and a near-infrared light range to be transmitted therethrough. As shown in the figure, a focus adjustment lens 203 and a diaphragm 205 are provided on an optical axis of the lens barrel 200. The focus adjustment lens 203 is configured so that it can be driven forward and backward in the optical axis direction by a lens driving unit 202. By changing the position of the focus adjustment lens 203 on the optical axis, the focus state of an optical image formed on an image capturing unit 304 of the body unit 300, which will be described later, can be adjusted. Furthermore, the diaphragm 205 is configured so that the open/closed state of the aperture state can be controlled by a diaphragm driving unit 204. By changing the open/closed state of the diaphragm 205, the amount of light incident on the body unit 300 and the depth of field can be adjusted. A lens control unit 201 controls each component of the lens barrel 200. The lens control unit 201 causes the lens driving unit 202 and the diaphragm driving unit 204 to perform driving control based on information which has been received from the body unit 300 via an electrical contact 206 and which is intended for control on the states of the focus adjustment lens 203 and the diaphragm 205.

The body unit 300 is configured to be capable of capturing images of light incident via the lens barrel 200 and recording the images.

A CPU 301 is a control apparatus that controls the operations of each block included in the body unit 300. The CPU 301 can control the operations of each block by reading out a control program for each block stored in a storage apparatus 302, deploying the control program to a memory 303, and executing the control program.

The storage apparatus 302 is a nonvolatile memory such as a flash memory. The storage apparatus 302 is an apparatus that can permanently store data, and can also store image data obtained as a result of shooting in addition to the control program for each block. The memory 303 is a volatile memory such as a DRAM. The memory 303 is a storage apparatus that has a faster data access speed than the storage apparatus 302, and can be used in deploying the control program, storing intermediate data output through the operations of each block, and the like.

The image capturing unit 304 includes, for example, an image sensor such as a CMOS sensor and a CCD, captures an image of light incident via the lens barrel 200, and outputs image data. More specifically, the image capturing unit 304 outputs image data (digital image signals) by applying A/D conversion to analog image signals obtained through photoelectric conversion applied to an optical image that has been formed by the lens barrel 200 on an image capturing plane of the image capturing unit 304. As shown in the figure, the image capturing unit 304 is configured to include a pixel array 3041, an A/D converter 3042, a timing generator 3043, and a transfer I/F 3044.

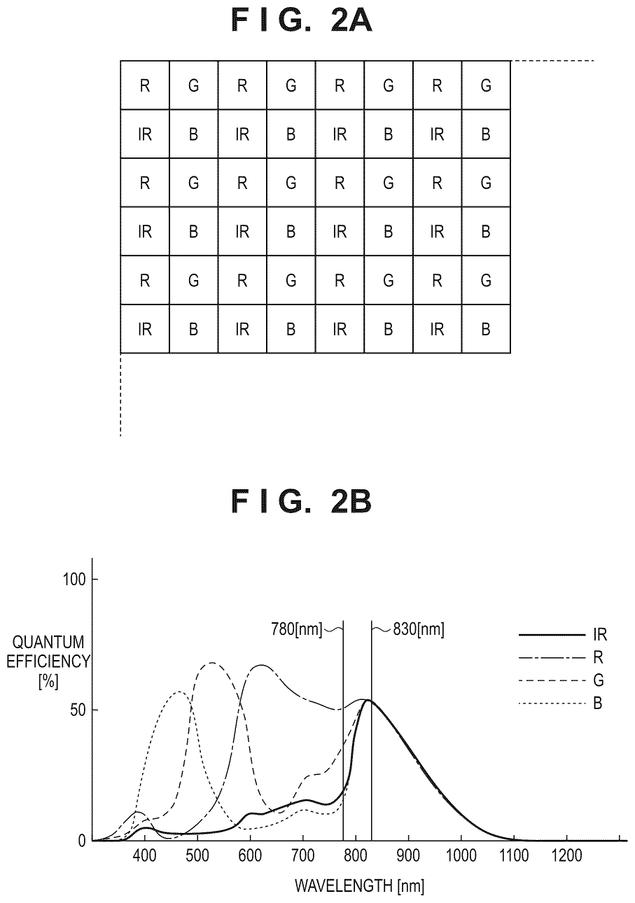

The pixel array 3041 includes pixels that are arrayed in a grid pattern as shown in FIG. 2A, and forms the image capturing plane. Each pixel includes a photoelectric converter element, a transfer transistor, an amplification transistor, and a source follower transistor; by connecting them to common vertical wires, pixel signals can be read out on a per-line unit.

As described above, the image capturing apparatus 100 of the present embodiment is configured to be capable of shooting a subject in relation to both of visible light (wavelengths of 380 nm to 780 nm) and near-infrared light (e.g., wavelengths of 780 nm to 1000 nm). In the body unit 300, in order to realize shooting of such light using one image sensor, filters are applied to the respective pixels in the pixel array 3041 so that neighboring pixels have different filters from each other as shown in FIG. 2A. In the example of the figure, three types of filters, namely red (R), green (G) and blue (B), are applied for visible light, whereas one type of filter, namely IR, is applied for near-infrared light. The present embodiment will be described under the assumption that the image sensor of the image capturing unit 304 is a CMOS sensor. The spectral sensitivity property of the CMOS sensor in relation to near-infrared light is as shown in FIG. 2B; the CMOS sensor can capture light with wavelengths of 780 nm to 1000 nm as near-infrared light. In the example of the figure, the peak bandwidth in which the sensitivity of the image sensor to near-infrared light increases is around 830 nm; hereinafter, 830 nm will be described as a representative wavelength of the near-infrared light range.

The A/D converter 3042 executes A/D conversion processing with respect to analog image signals that have been read out from the pixel array 3041, thereby converting them into digital image signals. The timing generator 3043 generates and outputs timing signals related to discrete operations of the image sensor. The timing signals are used to control the timings to, for example, reset, accumulate, transfer, and read out charges of the pixel array 3041. The transfer I/F 3044 transfers image data obtained through the A/D conversion to a block responsible for processing in a later stage related to image capturing/shooting (a correction unit 305 in the example of FIG. 1). The correction unit 305 corrects shading, dark current components, and the like of pixel values with respect to the input image data.

A photometering unit 306 measures a luminance distribution of a subject and outputs a photometering result (photometering data). In photometering, for example, image data obtained through image capturing can be used, and a luminance distribution of an entirety of a frame (the image data) can be measured by integrating luminance values for each arbitrary block. The photometering data is transferred to a later-described shooting control unit 309 as information of a subject light amount (Light Value; hereinafter referred to as an Lv value), and used in determination of an exposure amount (Exposure Value; hereinafter referred to as an Ev value) and exposure settings.

An in-focus unit 307 generates information for controlling the in-focus state of the subject in the optical image formed on the image capturing plane. This information transmits, for example, information of an image displacement amount (a defocus amount) related to an image estimated as the subject to an optical system control unit 311.

A ranging unit 308 measures a subject distance (ranging). The ranging unit 308 can obtain a distribution of the subject included in an image capturing range in the depth direction; for example, a distance measurement apparatus using LiDAR or the like can be used thereas. The ranging unit 308 obtains the distance between the subject and the image capturing plane as the subject distance based on the ranging result, and outputs the subject distance to the shooting control unit 309.

The shooting control unit 309 determines exposure settings (the Av value corresponding to the diaphragm value, the Tv value corresponding to the shutter speed, and the ISO sensitivity) in relation to shooting of the subject. As the image capturing apparatus 100 of the present embodiment performs shooting of visible light and near-infrared light with respect to the subject using a time-division method, the shooting control unit 309 determines exposure settings for each of visible light and near-infrared light. Based on the determined exposure settings, the shooting control unit 309 outputs a control instruction related to the exposure to an image capturing control unit 310 and the optical system control unit 311.

The image capturing control unit 310 controls the operations of the image capturing unit 304. More specifically, based on the input control instruction related to the exposure, the image capturing control unit 310 configures driving settings for the image capturing unit 304, and also transfers a readout timing (a synchronization signal). It is assumed that, in the body unit 300 of the present embodiment, the image capturing control unit 310 is configured to be capable of operating independently based on the control instruction from the shooting control unit 309 so that it can operate without using computation resources of the CPU 301.

The optical system control unit 311 transmits information for controlling the state of the lens barrel 200 to the lens control unit 201 via an electrical contact 312 (and the electrical contact 206). Upon receiving the information of the defocus amount supplied from the in-focus unit 307, the optical system control unit 311 determines a driving amount for the focus adjustment lens 203 (an amount of movement of the lens) and transmits the same to the lens control unit 201. Furthermore, upon receiving information pieces of the exposure settings supplied from the shooting control unit 309, the optical system control unit 311 transmits information pieces of the Av value and (if necessary) in-focus position, which are included thereamong, to the lens control unit 201. At this time, the lens control unit 201 can execute processing for converting the Av value into a driving amount for the diaphragm driving unit 204 (an amount by which the diaphragm 205 is opened), and converting the information of the in-focus position into a driving amount for the lens driving unit 202 (an amount of movement of the focus adjustment lens 203). Once the lens control unit 201 has thus received information pieces related to control on the state of the lens barrel 200, it transfers necessary information pieces to the lens driving unit 202 and the diaphragm driving unit 204, thereby controlling the states of the focus adjustment lens 203 and the diaphragm 205.

The electrical contact 312 and the electrical contact 206 are interfaces for exchanging information between the lens barrel 200 and the body unit 300. When the lens barrel 200 is attached to the body unit 300, the electrical contact 312 and the electrical contact 206 are electrically connected to each other and placed in a state where information can be exchanged therebetween. Although the interfaces of the lens barrel 200 and the body unit 300 are described as electrical contacts in the present embodiment, serial communication can also be performed, for example.

A codec 313 executes compression and decompression processing for image data. When shooting is performed, the codec 313 executes compression processing with respect to image data obtained through shooting based on information of a predetermined recording format. Also, when image data is reproduced, the codec 313 executes decompression processing with respect to, for example, image data recorded in the storage apparatus 302 based on information of a predetermined recording format. An external communication unit 314 controls external outputting of image data obtained through shooting. In a mode in which the image data shot by the image capturing apparatus 100 is used in real time as machine vision, the external communication unit 314 outputs the image data to an external apparatus via a communication I/F 315. In such a mode in which the image data is not recorded in the storage apparatus 302, it is permissible to adopt a configuration in which the codec 313 performs compression only. The communication I/F 315 is an interface for exchanging information between the body unit 300 and the external apparatus. Communication with the external apparatus may be performed by wire or wirelessly.

The following describes an overview of the determination of exposure settings made by the shooting control unit 309 in the body unit 300 configured in the foregoing manner. As described above, in the image capturing apparatus 100 of the present embodiment, in order to obtain an image by shooting a subject in relation to visible light (a visible light image) and an image by shooting the subject in relation to near-infrared light (a near-infrared light image), the shooting control unit 309 determines exposure settings for each of these images.

Prior to shooting of each image, the photometering unit 306 performs photometering with respect to each of the visible light and the near-infrared light, and outputs Lv values to the shooting control unit 309. In the image capturing apparatus 100 of the present embodiment, shooting is performed using the image sensor to which the R, G, B, and IR filters have been applied as shown in FIG. 2A. Therefore, the photometering unit 306 can obtain an Lv value related to the visible light (a first LV value) and an Lv value related to the near-infrared light (a second Lv value) from, for example, image data obtained through preliminary shooting based on the block-by-block integrated values of luminance values of each of RGB pixels and IR pixels inside a subject region.

Also, in order to shoot the visible light image and the near-infrared light image that capture the subject in a favorable in-focus state, the ranging unit 308 obtains information indicating a distribution of the subject in the depth direction. This information may include a representative value of subject distances, subject distances in the respective pixels of the subject region, and the length of the depth of the subject (the thickness of the subject in the depth direction).

The shooting control unit 309 first determines exposure settings in relation to the visible light. In general, exposure settings are determined by selecting a Tv value, an Av value, and an ISO sensitivity so as to satisfy a predetermined relationship while using the Lv value as a target exposure value (Ev value). Here, the Ev value, the Tv value, and the Av value satisfy the following relationship.

$$Ev value = Tv value + Av value$$

Furthermore, an ISO sensitivity corresponds to a correction stop of Ev value; when this correction stop (ISO correction stop) is taken into consideration, the above relationship formula is expressed as follows.

Ev value=Tv value+Av value−ISO correction stop

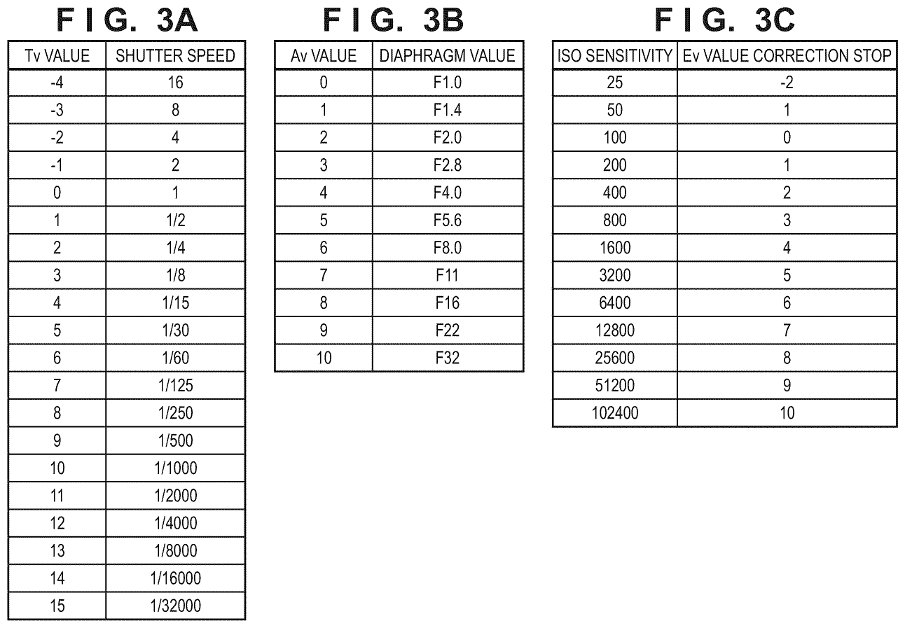

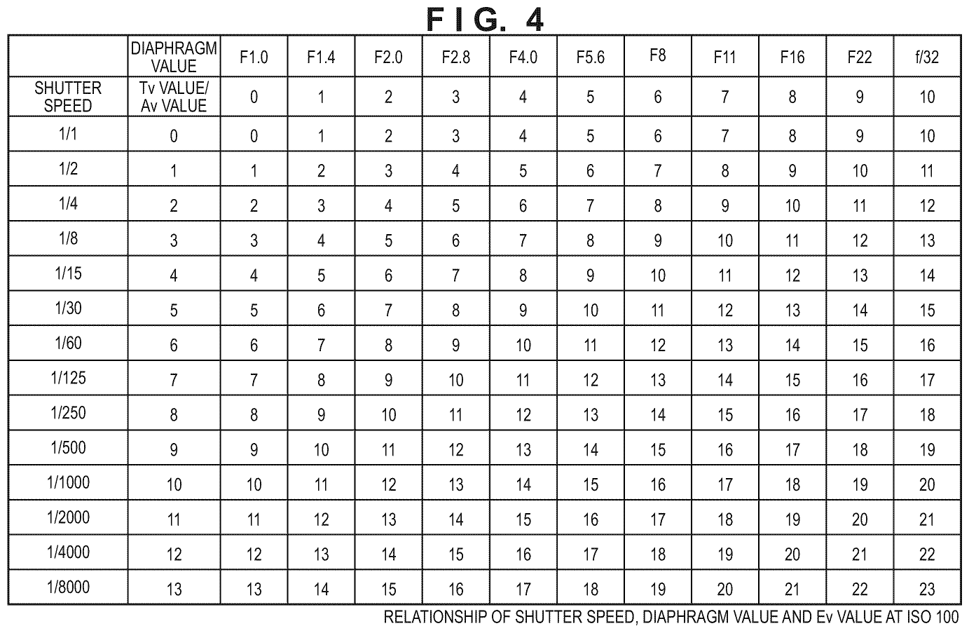

Here, the correspondence relationships between the Tv value and the shutter speed, between the Av value and the diaphragm value, and the ISO sensitivity and the correction stop, are as shown in FIGS. 3A, 3B, and 3C, respectively. That is to say, a reference Ev value (Ev=0) is defined as brightness of the subject that brings about appropriate exposure when shooting has been performed under an ISO sensitivity of 100, a diaphragm value of F1.0, and a shutter speed of one second. Therefore, for example, the Ev value that brings about appropriate exposure in combination with the Tv value and the Av value under the ISO 100 can be determined based on a table shown in FIG. 4.

Incidentally, in shooting of the visible light, as the influence of diffraction can become noticeable if the diaphragm value exceeds F22 (the aperture diameter becomes small), the upper limit of the diaphragm value is set in advance so as to avoid the occurrence of the influence of diffraction in configuring the exposure settings related to the visible light. That is to say, in determining the exposure settings related to the visible light, the shooting control unit 309 determines the Av value so that the diaphragm value becomes smaller than a predetermined upper-limit diaphragm value (the aperture is opened to be larger than a predetermined aperture diameter), and then determines the Tv value and the ISO sensitivity.

Meanwhile, the influence of diffraction varies between the visible light and the near-infrared light even if they have passed through the diaphragm 205 of the same aperture diameter. More specifically, as the near-infrared light has longer wavelengths, the light beam thereof that has passed through the diaphragm 205 of the same aperture diameter is subjected to the influence of diffraction, and an image thereof formed on the image capturing plane spreads wider. That is to say, when shooting has been performed using the diaphragm 205 of the same aperture diameter, the content of the near-infrared light image can appear low in resolution than the content of the visible light image. Therefore, in order to equalize the degrees of influence of diffraction on the visible light image and the near-infrared light image, the shooting control unit 309 determines the exposure settings related to the infrared light with reference to the exposure settings related to the visible light in addition to the second Lv value.

In order to evaluate the influence of diffraction, the image capturing apparatus 100 of the present embodiment uses the Airy disk diameter of light that is formed as an image on the image capturing plane as an evaluation value. The Airy disk denotes a disk-shaped region which is formed as an image on the image capturing plane during image capturing of a point light source via the image capturing optical system because the image has spread, instead of remaining as one point, due to the influence of diffraction via the diaphragm 205. That is to say, the Airy disk diameter is an index indicating the size of this disk-shaped region (the radius of the region).

The Airy disk diameter D can be derived as follows.

$$D = 1.22 \times λ \times F$$

Here, λ denotes the wavelength of light, and F denotes the diaphragm value (f-number). Therefore, in order to equalize the influences of diffraction during shooting of the near-infrared light image and during shooting of the visible light image, it is necessary to adjust the diaphragm value of the exposure settings related to the near-infrared light in accordance with the difference in wavelengths of the visible light and the near-infrared light. More specifically, as the near-infrared light has longer wavelengths than the visible light, the shooting control unit 309 sets the diaphragm value during shooting of the near-infrared light image to be smaller than that during shooting of the visible light image, that is to say, to achieve an aperture larger than the aperture during shooting of the visible light image.

Therefore, in configuring the exposure settings related to the near-infrared light, the shooting control unit 309 derives a diaphragm value that makes the Airy disk diameter not more than the Airy disk diameter during shooting of the visible light image based on the diaphragm value that has been determined for the exposure settings related to the visible light. Here, as each of the visible light range and the near-infrared light range includes various wavelengths, the shooting control unit 309 performs computation using representative wavelengths of the respective wavelength ranges. In other words, the shooting control unit 309 determines the diaphragm value during shooting of the near-infrared light image so that the Airy disk diameter does not exceed the Airy disk diameter of the visible light under the diaphragm value that has been determined for shooting of the visible light image.

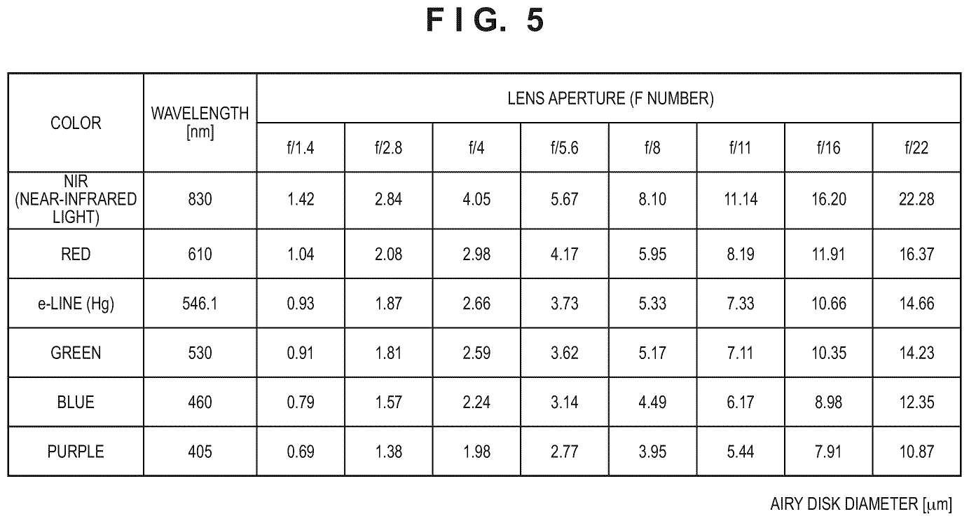

The representative wavelength of the visible light range can be, for example, a reference wavelength in optics and optical devices. The e-line (546.07 nm) or the d-line (587.56 nm) defined in ISO 7944:1998 can be used as the reference wavelength. In the present embodiment, the wavelength of the e-line (546.07 nm), which is a mercury (Hg) spectral line with a wavelength of 546.1 nm, is used as the representative wavelength of the visible light range. Meanwhile, 830 nm, which is the peak wavelength in the peak bandwidth according to the spectral sensitivity property of the image sensor in relation to the near-infrared light, is used as the representative wavelength of the near-infrared light range. Note that the Airy disk diameters that respectively correspond to the diaphragm values may be derived in advance on a wavelength-by-wavelength basis; for example, they may be held in the storage apparatus 302 as a table shown in FIG. 5, and the shooting control unit 309 may determine the diaphragm value during shooting of the near-infrared light image with reference to this table.

Hereinafter, for easy understanding of the disclosure, the exposure settings related to the visible light will be referred to as “first exposure settings”, and the exposure settings related to the near-infrared light will be referred to as “second exposure settings”. Also, the diaphragm value set for the exposure settings related to the visible light (the diaphragm value during shooting of the visible light image) will be referred to as a “first diaphragm value”, and the diaphragm value set for the exposure settings related to the near-infrared light (the diaphragm value during shooting of the near-infrared light image) will be referred to as a “second diaphragm value”. Furthermore, the Av value corresponding to the first diaphragm value set for the exposure settings related to the visible light will be referred to as a “first Av value”, and the Av value corresponding to the second diaphragm value set for the exposure settings related to the near-infrared light will be referred to as a “second Av value”. In addition, the representative wavelength of the visible light range and the representative wavelength of the near-infrared light range will be referred to as a “first wavelength” and a “second wavelength”, respectively.

That is to say, after determining the first exposure settings based on the first Lv value, the shooting control unit 309 first determines the second Av value based on the first Av value of these first exposure settings and the representative wavelengths of the respective wavelength ranges. Then, the shooting control unit 309 determines other parameters (the Tv value and the ISO sensitivity) of the second exposure settings based on this second Av value and the second Lv value.

As described above, with respect to the second exposure settings, the shooting control unit 309 determines a diaphragm value that achieves a large aperture compared to the first exposure settings. Meanwhile, when the diaphragm 205 is set to have a large aperture, the depth of field decreases as a consequence. That is to say, if the diaphragm value is adjusted so as to equalize the influences of diffraction on the visible light image and the near-infrared light image, a difference in the in-focus state of the subject may arise between the visible light image and the near-infrared light image. For this reason, the image capturing apparatus 100 of the present embodiment obtains near-infrared light images through focus bracket shooting, in which shooting is performed while making the in-focus position vary in sequence. That is to say, although the depth of field of the near-infrared light image obtained through a single shooting session decreases as a result of setting the second Av value to achieve a larger aperture than the first Av value, as shooting is performed multiple times using different in-focus positions, a plurality of near-infrared light images cover the subject that has been captured in the depth of field of the visible light image.

Therefore, the shooting control unit 309 also determines the number of shots in the focus bracket shooting and the in-focus positions that are set in the respective shots (these can be converted into driving amounts for an actuator of the lens driving unit 202), and includes them in the second exposure settings. The number of shots can be derived by, for example, dividing the range (distance) in the depth direction in which the subject to be shot in an in-focus state is distributed by the range (distance) in the depth direction included in the depth of field under the second Av value, and casting the result of the division to an integer value (by rounding up).

Here, the depth of field can be derived as a sum of a near depth of field and a far depth of field, which are derived based on the subject distance d of the subject in focus (the distance to the in-focus position), the second Av value, the focal length f of the image capturing optical system, and a defined value r of the permissible circle of confusion in the image capturing unit 304. The near depth of field can be derived as follows.

$$( Near depth of field ) = ( ( r \times ( second diaphragm value ) \times {d}^{2} ) / ( ( {f}^{2} + r \times ( second diaphragm value ) \times d ) )$$

Also, the far depth of field can be derived as follows.

$$( Far depth of field ) = ( ( r \times ( second diaphragm value ) \times {d}^{2} ) / ( {f}^{2} - r \times ( second diaphragm value ) \times d ) )$$

Here, for example, a larger one of the pixel pitch of the pixel array 3041 in the image capturing unit 304 and the Airy disk diameter corresponding to the second diaphragm value can be used as the defined value r of the permissible circle of confusion. Also, the focal length f has the property that the longer the wavelength, the larger the focal length f.

Furthermore, it is sufficient to determine the in-focus position in each shooting session based on a predetermined rule so that an entirety of a range to be shot in an in-focus state (a target range) falls within the depths of field of the plurality of near-infrared light images. For example, in a case where three shots are performed as the focus bracket shooting, the shooting control unit 309 can determine the in-focus position in each shot so that the near end of the depth of field in the first shooting session matches the near end of the target range, and the far end of the depth of field in the third shooting session matches the far end of the target range. Also, the in-focus position in the second shooting session can be determined so that the focus adjustment lens 203 is positioned at an intermediate position between the position of the focus adjustment lens 203 in the first shooting session and the position of the focus adjustment lens 203 in the third shooting session.

Once the shooting control unit 309 has determined the first exposure settings and the second exposure settings, information thereof is supplied to the shooting control unit 309 and the lens control unit 201, and the visible light image and the near-infrared light images are shot. In terms of use as machine vision, these images are preferably output in an easily comparable manner, and thus the CPU 301 outputs the obtained visible light image and the near-infrared light images in association with one another. As described above, the output may be output to the external apparatus via the external communication unit 314, or may be recording into the storage apparatus 302 via compression processing executed by the codec 313. At this time, the plurality of near-infrared light images obtained through the focus bracket shooting may be converted into one composite image by way of depth composition and output as the composite image, in consideration of convenience during comparison with the visible light image. The composite image can be generated by, for example, averaging the plurality of near-infrared light images, and can present a state of an expanded depth of field compared to one near-infrared light image.

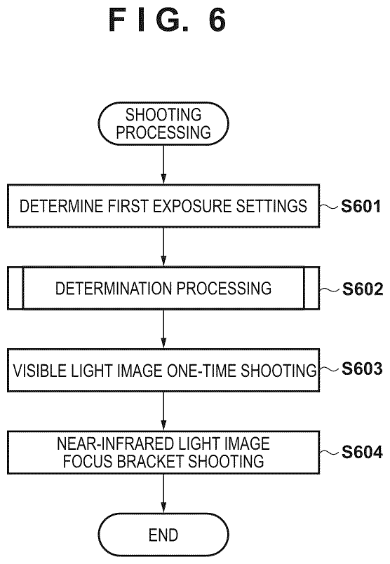

Using a flowchart of FIG. 6, the following describes specific processing in relation to shooting processing in which the image capturing apparatus 100 of the present embodiment outputs a visible light image and near-infrared light images of a subject. The processing corresponding to this flowchart can be realized by the CPU 301 reading out a corresponding processing program stored in, for example, the storage apparatus 302, deploying the processing program to the memory 303, and executing the processing program. The following description will be provided under the assumption that the present shooting processing is started, for example, upon detection of acceptance of a shooting instruction for two types of light via a non-illustrated user interface. Note, it is assumed that the photometering unit 306 and the ranging unit 308 have executed photometering and ranging, respectively, prior to the start of the present shooting processing. It is also assumed that the focus adjustment lens has been moved to a position where it focuses on the subject prior to the start of the present shooting processing.

In step S601, under control of the CPU 301, the shooting control unit 309 determines each parameter of the first exposure settings (including the first Av value) based on the input first Lv value.

In step S602, under control of the CPU 301, the shooting control unit 309 executes determination processing for determining each parameter of the second exposure settings based on the input second Lv value and the first Av value determined in step S601.

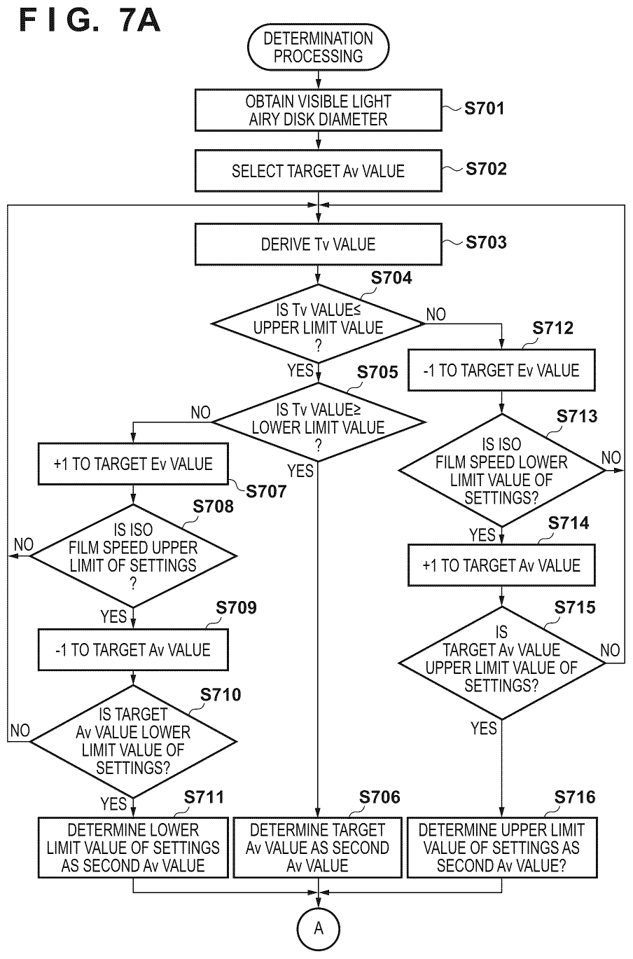

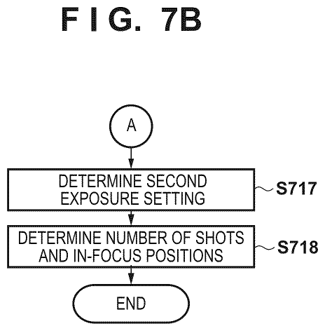

The details of the determination processing executed in the present step will now be described with reference to flowcharts of FIGS. 7A and 7B.

In step S701, based on the first diaphragm value and the first wavelength corresponding to the first Av value, the shooting control unit 309 obtains the Airy disk diameter under the exposure settings for the visible light image. The Airy disk diameter may be derived through computation, or may be obtained from a table or the like.

In step S702, the shooting control unit 309 selects a diaphragm value for near-infrared light that brings about an Airy disk diameter not more than the Airy disk diameter derived in step S701 as a target diaphragm value. Also, the shooting control unit 309 sets an Av value corresponding to this target diaphragm value as a target Av value.

In step S703, the shooting control unit 309 derives (tentatively determines) a Tv value to be included in the second exposure settings based on a target Ev value, which has been set based on the second Lv value, and the target Av value set in step S702. As described above, the Tv value can be derived as follows.

$$Tv value = target Ev value - target Av value$$

In step S704, the shooting control unit 309 determines whether the Tv value derived in step S703 is not more than a predetermined upper limit value. For example, in a case where the body unit 300 includes a mechanical shutter mechanism, the upper limit value of the Tv value can be set based on the performance of this mechanism. Alternatively, for example, in a case where a sensor driving method of the image capturing unit 304 is a rolling shutter method, the upper limit value of the Tv value can be determined based on the charge readout speed. The shooting control unit 309 causes the processing to proceed to step S705 in a case where the Tv value is not more than the upper limit value, and causes the processing to proceed to step S712 in a case where the Tv value exceeds the upper limit value.

In step S705, the shooting control unit 309 determines whether the Tv value derived in step S703 is not less than a predetermined lower limit value. The lower limit value of the Tv value can be set in accordance with, for example, the magnitude of movement of the subject. Here, although the lower limit value can be set to be low (the shutter speed can be set to be low) when the subject exhibits no movement, it is assumed that the lower limit value is set at a value that prevents a decrease in the throughput of the entire image capturing apparatus 100. The shooting control unit 309 causes the processing to proceed to step S706 in a case where it has determined that the Tv value is not less than the lower limit value, and causes the processing to proceed to step S707 in a case where it has determined that the Tv value falls below the lower limit value.

In step S706, the shooting control unit 309 determines the target Av value as the second Av value.

On the other hand, in a case where the shooting control unit 309 has determined that the Tv value falls below the lower limit value in step S705, it updates the target Ev value to a value that is larger than the target Ev value by one in step S707. That is to say, the shooting control unit 309 increases the sensitivity by increasing the ISO correction stop by one. That is to say, the shooting control unit 309 determines the ISO sensitivity one stop above as the second exposure settings.

In step S708, the shooting control unit 309 determines whether the ISO sensitivity determined in step S707 has reached an upper limit value of settings. The ISO sensitivity is changed by applying a gain to analog image signals prior to the conversion in the A/D converter 3042, or applying a digital gain after the conversion. More specifically, the ISO sensitivity is changed in accordance with a range of inclination of a reference signal of the A/D converter 3042, a gain setting for an analog amplifier in a stage prior thereto, and a gain setting for a digital gain in a later stage. Meanwhile, the image quality that is required in accordance with an intended use of image data obtained through shooting changes; therefore, for example, an upper limit value of settings and a lower limit value of settings are set for the ISO sensitivity in accordance with the intended use. In a case where the shooting control unit 309 has determined that the ISO sensitivity has reached the upper limit value of settings, it causes the processing to proceed to step S709. On the other hand, in a case where the shooting control unit 309 has determined that the ISO sensitivity has not reached the upper limit value of settings, it causes the processing to return to step S703, and derives (tentatively determines) a Tv value to be included in the second exposure settings again in relation to the updated target Ev value.

In step S709, the shooting control unit 309 updates the target Av value to a value that is smaller than the target Av value by one. That is to say, the shooting control unit 309 updates the target Av value to a diaphragm value that increases the aperture by one stop.

In step S710, the shooting control unit 309 determines whether the target Av value updated in step S709 has reached a lower limit value of settings of the Av value. Here, the lower limit value of settings of the Av value can be the state where the diaphragm 205 is opened (to the maximum aperture). In a case where the shooting control unit 309 has determined that the updated target Av value has reached the lower limit value of settings, it causes the processing to proceed to step S711. On the other hand, in a case where the shooting control unit 309 has determined that the updated target Av value has not reached the lower limit value of settings, it causes the processing to return to step S703, and derives (tentatively determines) a Tv value to be included in the second exposure settings again based on the updated target Av value and the updated target Ev value.

In step S711, the shooting control unit 309 determines the lower limit value of settings of the Av value as the second Av value.

On the other hand, in a case where the shooting control unit 309 has determined that the Tv value exceeds the upper limit value in step S704, it updates the target Ev value to a value that is smaller than the target Ev value by one in step S712. That is to say, the shooting control unit 309 reduces the sensitivity by decreasing the ISO correction stop by one. That is to say, the shooting control unit 309 determines the ISO sensitivity one stop below as the second exposure settings.

In step S713, the shooting control unit 309 determines whether the ISO sensitivity determined in step S712 has reached the lower limit value of settings. In a case where the shooting control unit 309 has determined that the ISO sensitivity has reached the lower limit value of settings, it causes the processing to proceed to step S714. On the other hand, in a case where the shooting control unit 309 has determined that the ISO sensitivity has not reached the lower limit value of settings, it causes the processing to return to step S703, and derives (tentatively determines) a Tv value to be included in the second exposure settings again in relation to the updated target Ev value.

In step S714, the shooting control unit 309 updates the target Av value to a value that is larger than the target Av value by one. That is to say, the shooting control unit 309 updates the target Av value to a diaphragm value that reduces the aperture by one stop.

In step S715, the shooting control unit 309 determines whether the target Av value updated in step S714 has reached an upper limit value of settings of the Av value. It is assumed here that the upper limit value of settings of the Av value is determined so as to achieve an Airy disk diameter that is not more than the Airy disk diameter under the exposure settings for the visible light image. That is to say, the upper limit value of settings of the Av value is a shooting condition where the aperture of the diaphragm 205 has been minimized to the extent that the influence of diffraction is deemed to be equal to that during shooting of the visible light image. In a case where the shooting control unit 309 has determined that the updated target Av value has reached the upper limit value of settings, it causes the processing to proceed to step S716. On the other hand, in a case where the shooting control unit 309 has determined that the updated target Av value has not reached the upper limit value of settings, it causes the processing to return to step S703, and derives (tentatively determines) a Tv value to be included in the second exposure settings again based on the updated target Av value and the updated target Ev value.

In step S716, the shooting control unit 309 determines the upper limit value of settings of the Av value as the second Av value.

In step S717, the shooting control unit 309 determines the determined second Av value, as well as the Tv value and the ISO sensitivity that have been determined by the time when the present step has been reached, as the second exposure settings.

In step S718, the shooting control unit 309 determines the number of shots in the focus bracket shooting for the near-infrared light images and the in-focus positions that are set in the respective shots based on the determined second Av value, includes information thereof in the second exposure settings, and completes the present determination processing. Here, information of the in-focus positions that are set in the respective shots may be information of the amount of movement of the focus adjustment lens 203.

Once each parameter of the second exposure settings has been determined through the determination processing in the foregoing manner, the CPU 301 causes the processing to proceed to step S603 of the shooting processing.

In step S603, under control of the CPU 301, the shooting control unit 309 supplies each parameter of the first exposure settings determined in step S601 to the image capturing control unit 310 and the optical system control unit 311, and causes a visible light image to be shot based on these first exposure settings. That is to say, the diaphragm driving unit 204 drives the diaphragm 205 to achieve the aperture size corresponding to the first Av value determined as the first exposure settings, and the image capturing control unit 310 exposes the pixel array 3041 to light for a time period corresponding to the Tv value determined as the first exposure settings. Based on control performed by the image capturing control unit 310, the image capturing unit 304 outputs image data (the visible light image) to which a gain corresponding to the ISO sensitivity determined as the first exposure settings has been applied.

In step S604, under control of the CPU 301, the shooting control unit 309 supplies each parameter of the second exposure settings determined in step S602 to the image capturing control unit 310 and the optical system control unit 311, and causes the focus bracket shooting of near-infrared light images to be performed based on these second exposure settings. That is to say, the lens driving unit 202 drives the focus adjustment lens 203 to be at the position corresponding to the in-focus position in each shooting session, and the diaphragm driving unit 204 drives the diaphragm 205 to achieve the aperture size corresponding to the second Av value determined as the second exposure settings. Also, the image capturing control unit 310 causes the pixel array 3041 to be exposed to light for a time period corresponding to the Tv value determined as the second exposure settings. Based on control performed by the image capturing control unit 310, the image capturing unit 304 outputs image data (the near-infrared light images) to which a gain corresponding to the ISO sensitivity determined as the second exposure settings has been applied. As the focus bracket shooting is performed, the lens driving unit 202 moves the focus adjustment lens 203 to different positions in sequence in the respective shots, and the image capturing unit 304 outputs a near-infrared light image in each shooting session. When the near-infrared light images of all shots have been output, the CPU 301 completes the present shooting processing.

As described above, the image capturing apparatus 100 of the present embodiment can determine exposure settings for obtaining a visible light image and near-infrared light images that exhibit a small deviation from each other in terms of apparent resolution. More specifically, at least during shooting of the near-infrared light images, a diaphragm value that achieves a larger aperture than a diaphragm value used during shooting of the visible light image is set; accordingly, the visible light image and the near-infrared light images can be output in which the deviation between the influences of diffraction caused by the difference in wavelengths of visible light and near-infrared light has been reduced.

Note that although the image capturing apparatus 100 of the present embodiment has been described to be an interchangeable lens type in which the visible light image and the near-infrared light images can be shot by attaching the lens barrel 200 to the body unit 300, the present disclosure is not limited to being embodied in this way. The image capturing optical system may be provided integrally with the body unit 300. Therefore, the positional relationship between the focus adjustment lens 203 and the diaphragm 205 inside the lens barrel 200 and various optical elements arranged on the optical axis, which are shown in FIG. 1, may be configured in any manner.

Furthermore, although the present embodiment has been described under the assumption that the representative wavelength of the visible light range is set based on the reference wavelength in optics and optical devices, and the representative wavelength of the near-infrared light is set based on the spectral sensitivity property of the image sensor, the present disclosure is not limited to being embodied in this way. The representative wavelength of each wavelength range may be configured so that, for example, it can be set by a user.

### First Modification Example

Although shooting of the above embodiment has been described under the assumption that the focus bracket shooting is performed for near-infrared light, the present disclosure is not limited to being embodied in this way. The present disclosure does not exclude a mode that outputs only a near-infrared light image obtained through one-time shooting with respect to near-infrared light, similarly to the case of visible light. For example, in a case where the shooting control unit 309 has determined that the distribution of a subject in the depth direction falls within the depth of field associated with the second diaphragm value, it may configure the second exposure settings so that one-time shooting is performed, rather than the focus bracket shooting, for near-infrared light. At this time, the second exposure settings may be configured to include information indicating that normal shooting is to be performed once (one-time shooting) instead of information indicating multiple shots, and may be configured to include only information of one type of in-focus position instead of information of a plurality of types of in-focus positions.

### Second Modification Example

Although the above embodiment has been described under the assumption that only one-time shooting is performed with respect to visible light in the shooting processing, the present disclosure is not limited to being embodied in this way. The present disclosure does not exclude a mode that outputs a plurality of visible light images by performing the focus bracket shooting with respect to visible light.

### Third Modification Example

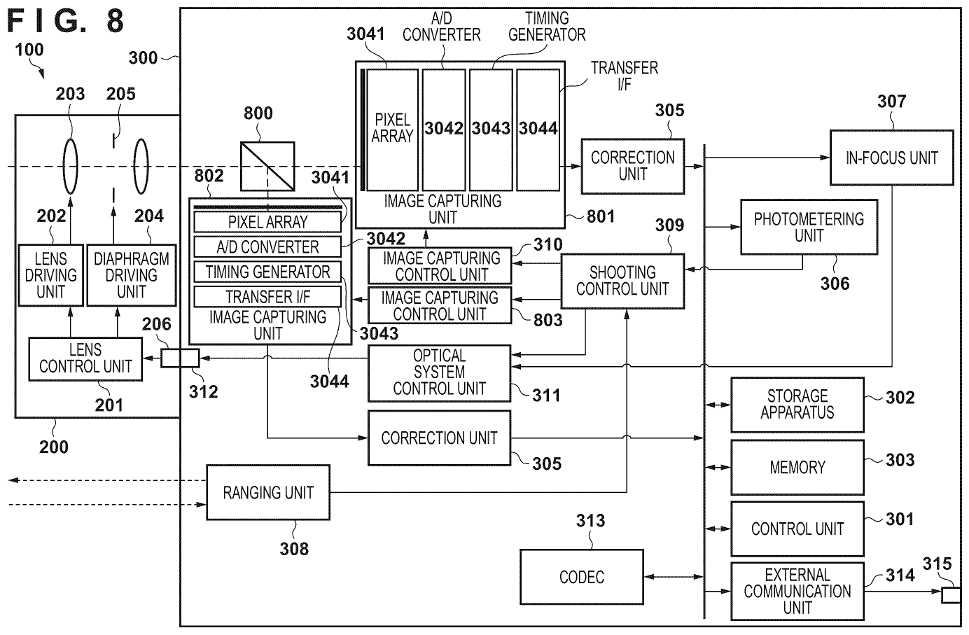

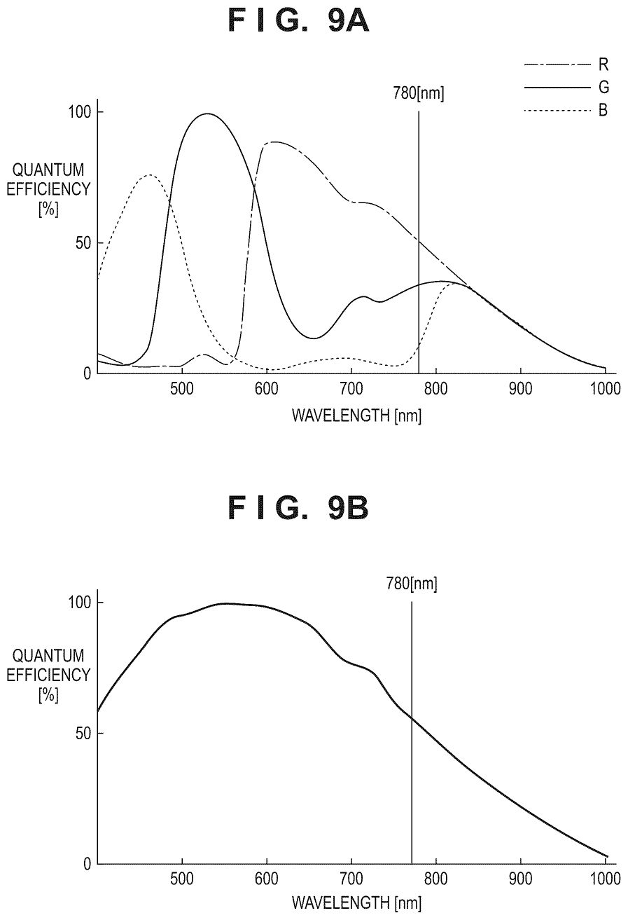

Although the above embodiment and modification examples have been described in relation to a mode in which a visible light image and near-infrared light images can be shot using one image sensor by applying the R, G, B, and IR filters to the discrete pixels in the pixel array 3041, the present disclosure is not limited to being embodied in this way. For example, there is a configuration in which the body unit 300 includes an image capturing unit 801 for shooting visible light and an image capturing unit 802 for shooting near-infrared light as shown in FIG. 8, and the former and the latter shoot a visible light image and near-infrared light images, respectively. The configurations of such image capturing units 801 and 802 can be realized by, for example, using an image sensor to which color filters of the Bayer arrangement have been applied in the former, and using an image sensor that does not include color filters and is capable of performing monochrome shooting in the latter. That is to say, the image sensor of the former exhibits the spectral sensitivity property shown in FIG. 9A, and the image sensor of the latter exhibits the spectral sensitivity property shown in FIG. 9B.

Note that in a case where CMOS sensors are used as the image sensors, the image sensors have sensitivity to a near-infrared wavelength range (780 nm to 1000 nm). Therefore, in a mode in which the identical CMOS sensors are used in the image capturing unit 801 and the image capturing unit 802, a similar configuration can also be realized by applying an infrared cut filter to the former and applying a band-pass filter, which allows near-infrared light to be transmitted therethrough, to the latter. That is to say, the image capturing unit 801 and the image capturing unit 802 are different from each other in that the light component that can be recorded by each pixel of the pixel array 3041 is one of R, G, and B in the former, and only IR in the latter.

In the example of the figure, shooting can be performed by dispersing light incident via the lens barrel 200 with use of a half mirror 800, and forming images thereof on the respective image capturing units. The image capturing plane of the pixel array 3041 in the image capturing unit 801 and the image capturing plane of the pixel array 3041 in the image capturing unit 802 are located at positions that are conjugate via the half mirror 800. In this case, the shooting control unit 309 supplies each parameter of the first exposure settings to the image capturing control unit 310 and the optical system control unit 311, and supplies each parameter of the second exposure settings to an image capturing control unit 803 and the optical system control unit 311. The image capturing control unit 803 may have a functional configuration similar to that of the image capturing control unit 310, and controls the operations of the image capturing unit 802 based on the parameters (Tv value and ISO sensitivity) of the input second exposure settings.

### Second Embodiment

Incidentally, in a case where the body unit 300 is configured as shown in FIG. 8, it is also possible to shoot a visible light image and near-infrared light images without using the time-division method. However, the optical images that are formed on the image sensor of the image capturing unit 801 and the image sensor of the image capturing unit 802 via the half mirror 800 are different from each other in the in-focus position because visible light and near-infrared light have different wavelengths. Therefore, in a case where one-time shooting is performed for both of the visible light and the near-infrared light, the focus adjustment lens 203 needs to be moved to the in-focus positions that respectively correspond to the visible light and the near-infrared light, and therefore it is difficult to shoot two types of images in the same time period. Conversely, in a case where the focus bracket shooting is performed for both of the visible light and the near-infrared light, a visible light image and a near-infrared light image can be shot simultaneously in a shooting occasion where the same in-focus position is used. That is to say, the two types of images can be shot simultaneously in a section that includes an overlap between a range in which the focus adjustment lens 203 is driven in relation to the focus bracket shooting for the visible light and a range in which the focus adjustment lens 203 is driven in relation to the focus bracket shooting for the near-infrared light. That is to say, the efficiency of shooting can be increased when a visible light image and a near-infrared light image are shot in the same time period by merging the ranges in which the focus adjustment lens 203 is driven for the focus bracket shooting. In other words, in a case where the focus bracket shooting is performed for the visible light and the near-infrared light, visible light images and near-infrared light images corresponding to certain in-focus positions can be efficiently obtained by moving the focus adjustment lens 203 in the same process.

Meanwhile, as described above, regarding the first exposure settings and the second exposure settings, the second diaphragm value included in the latter is set to achieve a larger aperture than the first diaphragm value included in the former. That is to say, in order for the image capturing unit 801 and the image capturing unit 802 to simultaneously shoot the light beams incident via one image capturing optical system as in the image capturing apparatus 100 of the present embodiment, it is necessary to bring not only the range in which the focus adjustment lens 203 is driven, but also the diaphragm value, into conformity with the shooting. Here, if the first diaphragm value is used, the apparent resolution of the near-infrared light images can be impaired due to the influence of diffraction; thus, the image capturing apparatus 100 of the present embodiment performs the focus bracket shooting for the visible light and the near-infrared light using the second diaphragm value. That is to say, as visible light images are shot by setting the second diaphragm value, which achieves a larger aperture, the depth of field becomes small compared to a case where shooting is performed using the first diaphragm value, and the in-focus position during the focus bracket shooting needs to be set based on the second diaphragm value. Therefore, in a case where the focus bracket shooting is performed for both of the visible light and the near-infrared light, the shooting control unit 309 determines the second diaphragm value based on the first diaphragm value, and then determines the in-focus position during the focus bracket shooting for the visible light and the near-infrared light based on this second diaphragm value.

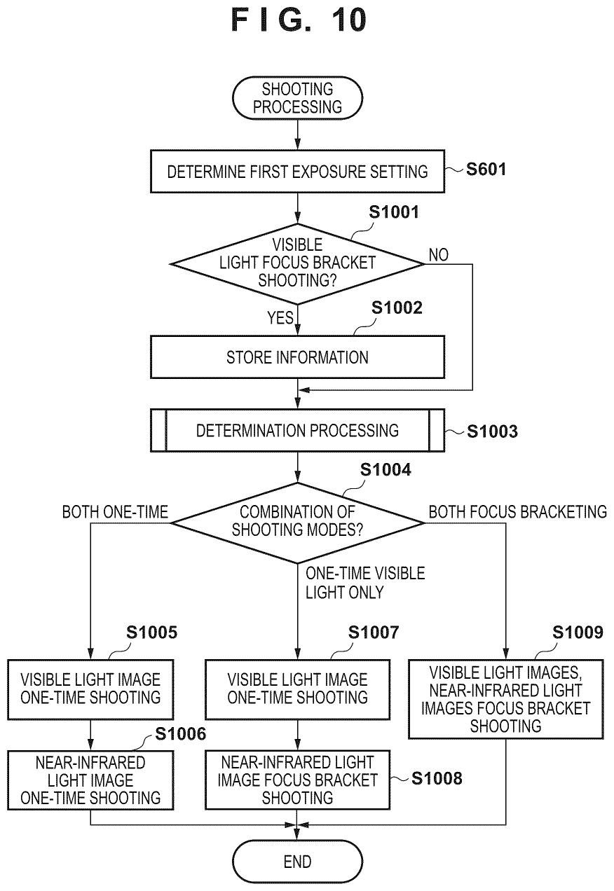

Using a flowchart of FIG. 10, the following describes specific processing in relation to shooting processing in which the image capturing apparatus 100 of the present embodiment outputs a visible light image and a near-infrared light image of a subject. The processing corresponding to this flowchart can be realized by the CPU 301 reading out a corresponding processing program stored in, for example, the storage apparatus 302, deploying the processing program to the memory 303, and executing the processing program. The following description will be provided under the assumption that the present shooting processing is started, for example, upon detection of acceptance of a shooting instruction for two types of light via a non-illustrated user interface.

Note, it is assumed that the photometering unit 306 and the ranging unit 308 have executed photometering and ranging, respectively, prior to the start of the present shooting processing. It is also assumed that the focus adjustment lens has been moved to a position where it focuses on the subject prior to the start of the present shooting processing. Furthermore, regarding the present shooting processing, steps that execute processing similar to the shooting processing of the first embodiment are given the same reference numerals thereas, and a description thereof is omitted; hereinafter, only steps that execute operations unique to the present embodiment will be described.

Once the shooting control unit 309 has determined each parameter of the first exposure settings in step S601, it determines, under control of the CPU 301, whether the focus bracket shooting is to be performed for the visible light in step S1001. The determination of the present step can be made based on whether the distribution of the subject in the depth direction (the depth thereof) is outside the range of the depth of field associated with the first diaphragm value (the distribution does not fall inside the depth of field). The shooting control unit 309 causes the processing to proceed to step S1002 in a case where it has determined that the focus bracket shooting is to be performed for the visible light, and causes the processing to proceed to step S1003 in a case where it has determined that the focus bracket shooting is not to be performed for the visible light.

In step S1002, under control of the CPU 301, the shooting control unit 309 stores information indicating that the focus bracket shooting is to be performed into the memory 303. Note, it is assumed that an initial value indicating that the focus bracket shooting is not performed (one-time shooting is performed) for the visible light and the near-infrared light is set at the start of the present shooting processing.

In step S1003, under control of the CPU 301, the shooting control unit 309 executes determination processing for determining each parameter of the second exposure settings based on the input second Lv value and the first Av value determined in step S601.

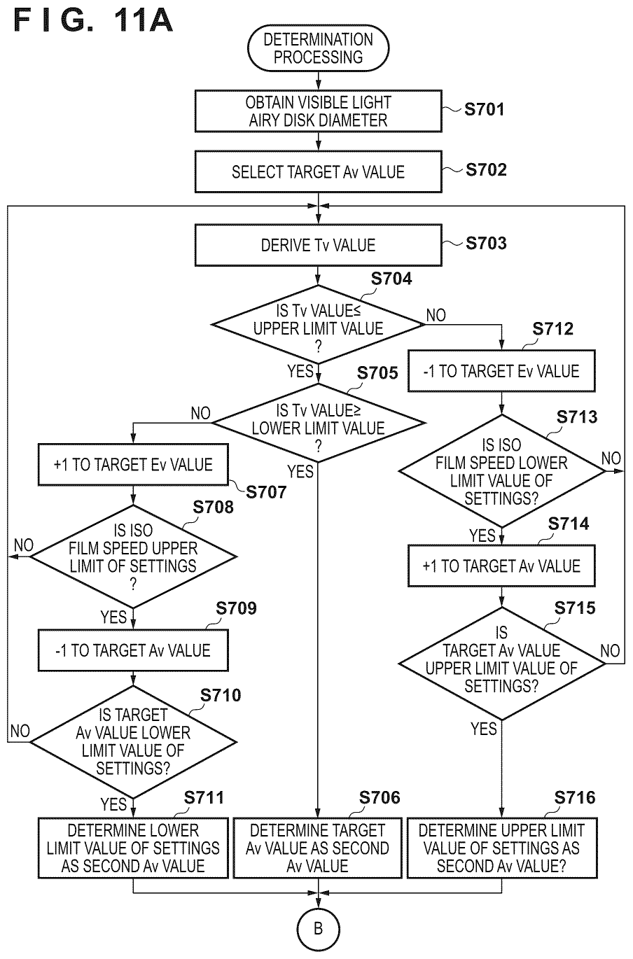

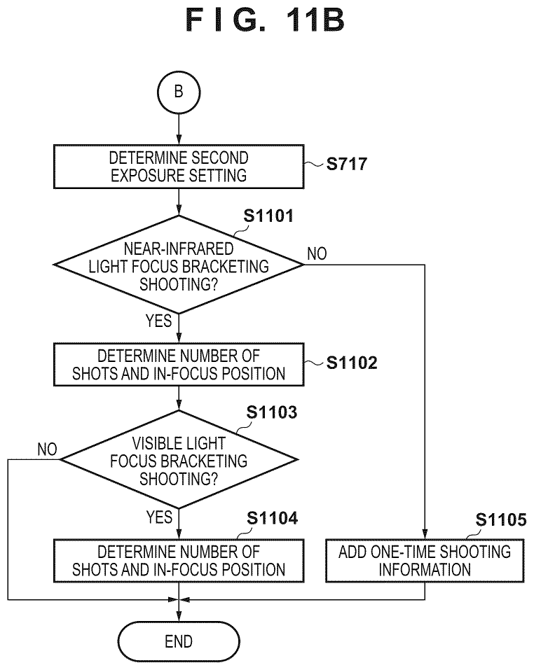

The details of the determination processing executed in the present step will now be described with reference to flowcharts of FIGS. 11A and 11B. Note that in the description of the present determination processing, steps that execute processing similar to the determination processing of the first embodiment are given the same reference numerals thereas, and a description thereof is omitted; hereinafter, only steps that execute operations unique to the present embodiment will be described.

Once each parameter of the second exposure settings has been determined in step S717, the shooting control unit 309 determines whether to perform the focus bracket shooting for the near-infrared light in step S1101. The determination of the present step can be made based on whether the distribution of the subject in the depth direction (the depth thereof) is outside the range of the depth of field associated with the second diaphragm value (the distribution does not fall inside the depth of field). Note that in a case where it has been determined that the focus bracket shooting is to be performed for the visible light, it is possible to determine that the focus bracket shooting is to be performed also for the near-infrared light because, with regard to the near-infrared light, the depth of the same subject is shot using the second diaphragm value that achieves a larger aperture. The shooting control unit 309 causes the processing to proceed to step S1102 in a case where it has determined that the focus bracket shooting is to be performed for the near-infrared light, and causes the processing to proceed to step S1105 in a case where it has determined that the focus bracket shooting is not to be performed for the near-infrared light.

In step S1102, the shooting control unit 309 determines the number of shots in the focus bracket shooting for the near-infrared light images and the in-focus positions that are set in the respective shots, and includes information thereof in the second exposure settings.

In step S1103, the shooting control unit 309 determines whether it has been determined that the focus bracket shooting is to be performed for the visible light. The determination of the present step can be made based on whether the memory 303 stores information to that effect. In a case where it has been determined that the focus bracket shooting is to be performed for the visible light, the shooting control unit 309 causes the processing to proceed to step S1104. On the other hand, in a case where it has not been determined so, that is to say, in a case where it has been determined that one-time shooting is to be performed for the visible light, the shooting control unit 309 completes the present determination processing.

In step S1104, the shooting control unit 309 determines the number of shots for simultaneous execution of the focus bracket shooting for the visible light images and the near-infrared light images and the in-focus positions that are set in the respective shots, and completes the present determination processing. That is to say, the shooting control unit 309 merges the ranges in which the focus adjustment lens 203 is moved in the focus bracket shooting for the visible light images and the focus bracket shooting for the near-infrared light images, thereby specifying a movement range of the focus adjustment lens 203 that ultimately covers both ranges. Then, the shooting control unit 309 determines the in-focus position in each shooting session based on this movement range.

As described above, the in-focus range differs between the visible light and the near-infrared light because they have different wavelengths. That is to say, in order to complete the focus bracket shooting for the visible light and the near-infrared light in a period in which the focus adjustment lens 203 moves once in this range, the shooting control unit 309 needs to set the lens movement range so as to cover both of the movement ranges in which the focus adjustment lens 203 should be moved for the visible light and the near-infrared light. This is also an adjustment for absorbing the difference between the in-focus positions for the visible light and the near-infrared light, which occurs due to chromatic aberration.

Here, in order to perform the focus bracket shooting for the visible light image and the near-infrared light image simultaneously in a period in which the focus adjustment lens 203 moves once, the image capturing apparatus 100 of the present embodiment changes the first diaphragm value included in the first exposure settings to the second diaphragm value determined for the near-infrared light. Therefore, the image capturing apparatus 100 of the present embodiment determines information of the number of shots and the in-focus positions in the focus bracket shooting for the visible light image in the present determination processing. When the number of shots in the focus bracket shooting of the visible light images is determined based on the second diaphragm value, the number can be large compared to a case where it is determined based on the first diaphragm value, but control on the lens driving unit 202 and each image capturing unit can be simplified.

The shooting control unit 309 not only updates the first diaphragm value to the value of the second diaphragm value, but also determines information of the number of shots and the in-focus positions in the focus bracket shooting of the visible light images based on the depth of field associated with the updated diaphragm value. At this time, regarding an in-focus range that has already been established to perform shooting by moving the focus adjustment lens 203 therein in connection with the focus bracket shooting for the near-infrared light, information of the in-focus positions included in the second exposure settings is used.

On the other hand, regarding an in-focus position that is not included in the in-focus range that has been established in connection with the near-infrared light, it can be set by using, as a reference, the difference of the moving amount of the focus adjustment lens 203 between continuous in-focus positions that have been determined for the focus bracket shooting of the near-infrared light images, for example. Regarding an in-focus range that is brought into focus only in the focus bracket shooting for the visible light, it is sufficient that the shooting control unit 309 determines the lens positions at an interval of the difference of the moving amount in the section in which the focus adjustment lens 203 is moved, and determines the in-focus position in each shooting session in accordance with the determined lens positions. At this time, the shooting control unit 309 can also specify the number of shots to be performed with respect to the in-focus range associated only with the visible light. Therefore, the shooting control unit 309 adds this number of shots and the number of shots determined for the near-infrared light to derive the number of shots in the execution of the entire focus bracket shooting for the visible light images and the near-infrared light images. This number of shots is the number of times the focus adjustment lens 203 is moved to different in-focus positions in the entire focus bracket shooting for the visible light images and the near-infrared light images. The shooting control unit 309 outputs, to the image capturing control unit 310 and the optical system control unit 311, information of the number of shots and the in-focus position in each shooting session that have been obtained in the foregoing manner.

Note that in a period in which the focus adjustment lens 203 moves once, it is not necessary for the image capturing apparatus 100 of the present embodiment to perform shooting of both of the visible light image and the near-infrared light image at each in-focus position. That is to say, the focus bracket shooting of the visible light images is performed in a period in which the focus adjustment lens 203 is at the positions corresponding to the in-focus positions that have been determined for the visible light. Also, the focus bracket shooting of the near-infrared light images is performed in a period in which the focus adjustment lens 203 is at the positions corresponding to the in-focus positions that have been determined for the near-infrared light. Therefore, shooting of both of the visible light image and the near-infrared light image is performed only in the case of the in-focus position that has been commonly determined for both images. It is assumed that such information indicating which one of the image capturing unit 801 and the image capturing unit 802 performs shooting at which in-focus position is included in the first exposure settings and the second exposure settings, for example.

On the other hand, in a case where the shooting control unit 309 has determined that the focus bracket shooting is not to be performed for the near-infrared light in step S1101, it includes information indicating that a near-infrared light image is to be shot through one-time shooting in the second exposure settings in step S1105, and completes the present determination processing.

Once the determination processing has been thus completed, the shooting control unit 309 determines, under control of the CPU 301, a combination of shooting modes for the visible light image and the near-infrared light image in step S1004 of the shooting processing. The shooting control unit 309 causes the processing to proceed to step S1005 in a case where it has determined that one-time shooting is to be performed for both of the visible light image and the near-infrared light image. Also, the shooting control unit 309 causes the processing to proceed to step S1007 in a case where it has determined that one-time shooting is to be performed for the visible light image and the focus bracket shooting is to be performed for the near-infrared light images. Furthermore, the shooting control unit 309 causes the processing to proceed to step S1009 in a case where it has determined that the focus bracket shooting is to be performed for both of the visible light images and the near-infrared light images.

In step S1005, under control of the CPU 301, the shooting control unit 309 supplies each parameter of the first exposure settings determined in step S601 to the image capturing control unit 310 and the optical system control unit 311, and causes one-time shooting of the visible light image to be performed based on these first exposure settings. In response, the image capturing unit 801 outputs image data of the visible light image based on control performed by the image capturing control unit 310.

In step S1006, under control of the CPU 301, the shooting control unit 309 supplies each parameter of the second exposure settings determined in step S1003 to the image capturing control unit 310 and the optical system control unit 311, and causes one-time shooting of the near-infrared light image to be performed based on these second exposure settings. In response, the image capturing unit 802 outputs image data of the near-infrared light image based on control performed by the image capturing control unit 310. When the near-infrared light image has been output, the CPU 301 completes the present shooting processing.

Also, in a case where one-time shooting is to be performed for the visible light image and the focus bracket shooting is to be performed for the near-infrared light images, the shooting control unit 309 performs control that causes one-time shooting of the visible light image to be performed under control of the CPU 301 in step S1007. That is to say, the shooting control unit 309 supplies each parameter of the first exposure settings determined in step S601 to the image capturing control unit 310 and the optical system control unit 311, and causes one-time shooting of the visible light image to be performed based on these first exposure settings. In response, based on control performed by the image capturing control unit 310, the image capturing unit 801 outputs image data (the visible light image) to which a gain corresponding to the ISO sensitivity determined as the first exposure settings has been applied.

In step S1008, under control of the CPU 301, the shooting control unit 309 supplies each parameter of the second exposure settings determined in step S1003 to the image capturing control unit 310 and the optical system control unit 311, and causes the focus bracket shooting of the near-infrared light images to be performed based on these second exposure settings. In response, based on control performed by the image capturing control unit 310, the image capturing unit 802 outputs image data (the near-infrared light images) to which a gain corresponding to the ISO sensitivity determined as the second exposure settings has been applied. As the focus bracket shooting is performed, the lens driving unit 202 moves the focus adjustment lens 203 to different positions in sequence in the respective shots, and the image capturing unit 802 outputs a near-infrared light image in each shooting session. When the near-infrared light images of all shots have been output, the CPU 301 completes the present shooting processing.

Furthermore, in a case where the focus bracket shooting is to be performed for both of the visible light images and the near-infrared light images, the shooting control unit 309 performs control that causes the focus bracket shooting to be performed for the visible light images and the near-infrared light images simultaneously under control of the CPU 301 in step S1009. That is to say, the shooting control unit 309 supplies each parameter of the first exposure settings and the second exposure settings determined in steps S601 and S1003 to the image capturing control unit 310 and the optical system control unit 311, and causes the focus bracket shooting of the visible light images and the near-infrared light images to be performed based thereon.

The lens driving unit 202 drives the focus adjustment lens 203 to be at the position corresponding to the in-focus position in each shooting session, and the diaphragm driving unit 204 drives the diaphragm 205 to achieve the aperture size corresponding to the second Av value that has been commonly determined for the visible light and the near-infrared light. Also, the image capturing control unit 310 exposes the pixel array 3041 in the image capturing unit 801 to light for a time period corresponding to the Tv value determined as the first exposure settings, and exposes the pixel array 3041 in the image capturing unit 802 to light for a time period corresponding to the Tv value determined as the second exposure settings. Based on control performed by the image capturing control unit 310, the image capturing unit 801 outputs image data of the visible light images to which a gain corresponding to the ISO sensitivity determined as the first exposure settings has been applied. Furthermore, based on control performed by the image capturing control unit 310, the image capturing unit 802 outputs image data of the near-infrared light images to which a gain corresponding to the ISO sensitivity determined as the second exposure settings has been applied.

As the focus bracket shooting is performed, the lens driving unit 202 moves the focus adjustment lens 203 to different positions in sequence in the respective shots, and the image capturing unit 801 and the image capturing unit 802 output image data in shots for which the execution of shooting has been designated. When at least one of the near-infrared light image and the near-infrared light image has been output in every shooting session, the CPU 301 completes the present shooting processing.

In this way, the image capturing apparatus 100 of the present embodiment can increase the efficiency of control in a mode in which the visible light images and the near-infrared light images are obtained through the focus bracket shooting.

Note that although the present embodiment has been described under the assumption that the image capturing unit(s) corresponding to the in-focus position is caused to perform shooting in each shooting session in a mode in which the focus bracket shooting is performed for both of the visible light images and the near-infrared light images, the present disclosure is not limited to being embodied in this way. For example, it is permissible to perform control so that both of the visible light image and the near-infrared light image are shot in every shooting session, and only the images that are necessary among them (the images included in the in-focus range) are extracted at the time of output. Alternatively, for example, images that do not favorably show the state of the subject may be excluded by selecting only necessary images as composition targets when generating a composite image.

Furthermore, although the present embodiment has been described under the assumption that the number of shots and the in-focus position in each shooting session for a case where the focus bracket shooting is performed for both of the visible light images and the near-infrared light images are derived in step S1104 of the determination processing, the present disclosure is not limited to being embodied in this way. As the number of shots and the changes in the in-focus position associated with the changes in the diaphragm value are determined in accordance with, for example, the relationship between the representative wavelength of the visible light range and the representative wavelength of the near-infrared light range, they may be measured/derived in advance for each of a plurality of types of representative subject distances and stored into the storage apparatus 302.

### Fourth Modification Example

The above embodiments and modification examples have been described under the assumption that the image capturing apparatus 100 is placed in an environment where a subject can be shot in relation to visible light and near-infrared light. However, in a case where shooting is performed indoors by using, for example, a fluorescent lamp as lighting, emitted light may not include light in the near-infrared light range. Furthermore, in a case where a blocking object is placed between a subject and a light source of visible light, there is a possibility that the luminance of the subject becomes unstable, and an obtained visible light image cannot be effectively used in machine vision, for example. For this reason, the image capturing apparatus 100 may be configured to include various types of light sources that irradiate the subject with corresponding light in synchronization with shooting. For example, a white LED can be used as a light source of visible light. Also, for example, an LED that emits near-infrared light (hereinafter referred to as a near-infrared LED) can be used as a light source of near-infrared light.

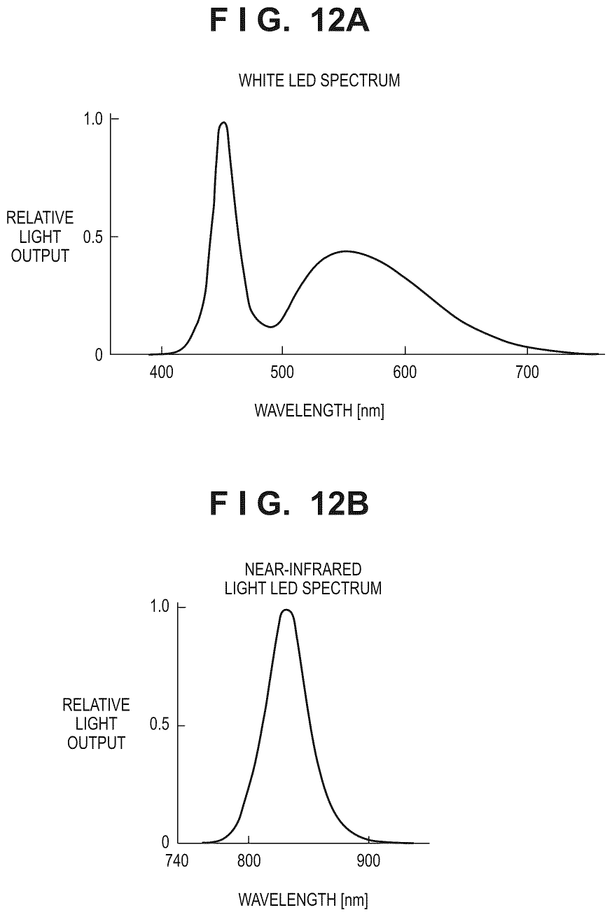

In a case where such light emitting elements are used, it is sufficient to set the representative wavelength of each wavelength range in a shot image in accordance with the light emitting elements used. The white LED exhibits the spectral property shown in FIG. 12A, for example. As shown in the figure, although light of the white LED has a sharp peak in a blue light range, the representative wavelength of the range of 400 nm to 780 nm may be determined to be around 560 nm, which is the center of the range. Meanwhile, the near-infrared LED exhibits the spectral property shown in FIG. 12B, for example. As shown in the figure, regarding light of the near-infrared LED, the representative wavelength may be determined to be around 830 nm, which is the luminescence center.

The image capturing apparatus 100 including such light sources performs control so as to cause each light emitting element to emit light when, for example, the photometering unit 306 performs photometering. Control on each light emitting element may be performed by, for example, a light emission control unit (not shown) that operates in accordance with commands from the shooting control unit 309 and the CPU 301. At the time of photometering, the light emission control unit causes the white LED and the near-infrared LED to emit light as preliminary light emission, and the image capturing unit 304 captures an image of a subject that has been irradiated with light of these LEDs and outputs the image, which is used in photometering performed by the photometering unit 306. At this time, the white LED and the near-infrared LED can emit light simultaneously because their spectral properties do not overlap as shown in FIGS. 12A and 12B. Furthermore, the light emission control unit may control light emission of each LED so that the luminance of an arbitrary region inside the image matches a predetermined light amount. Here, the predetermined light amount can be defined so that it corresponds to an arbitrary section in the table of FIG. 5 under, for example, the f-number corresponding the maximum aperture, while assuming that the obtained Lv value is the Ev value. Note that controlling the light amount at this timing can simplify the determination of each parameter of the exposure settings in the determination processing and the like.

Furthermore, when a visible light image and a near-infrared light image are shot in the shooting processing, the light emission control unit controls the corresponding LEDs to be in a light-emitting state.

Note that although the image capturing apparatus 100 of the present modification example has been described under the assumption that it includes light sources that emit light constantly, such as LEDs, it goes without saying that the image capturing apparatus 100 may be configured to include a light source that emits light instantaneously, such as a flash. In the case of a light source such as a flash, a guide numbers is defined, and the diaphragm value (f-number) can uniquely define the relationship among the amount of emitted light, the subject distance, and the ISO sensitivity. Therefore, if the shutter speed is set to be lower than the flash synchronization speed, photometering processing before the shooting processing becomes unnecessary (although the options for the Tv value are narrowed).

Furthermore, although the present modification example has been described using a configuration in which the image capturing apparatus 100 includes light sources that emit light of two types of wavelength ranges used in shooting, the present disclosure is not limited to being embodied in this way. It is permissible to adopt a configuration in which at least one of the light sources is provided outside the image capturing apparatus 100, and irradiates the subject in accordance with a control signal output from the image capturing apparatus 100. The external light source can also be a light source capable of emitting light of a plurality of types of wavelength ranges. In this case, the light emission control unit supplies, to the external light source, information of a wavelength range of light to be emitted and the representative wavelength. The information of the wavelength range of light to be emitted by the external light source and the representative wavelength may be configured so that a user can set them on the body unit 300 via a GUI, for example.

### Fifth Modification Example

Although the above embodiments and modification examples have been described under the assumption that the image capturing apparatus 100 is configured to be capable of shooting a visible light image and a near-infrared light image via one image capturing optical system, the present disclosure is not limited to being embodied in this way. In the present disclosure, shooting of the visible light image and the near-infrared light image need not be performed using the same image capturing optical system as long as the diaphragm value determined for the near-infrared light achieves a larger aperture than the diaphragm value during shooting of the visible light image so as to reduce the deviation between the influences of diffraction on the visible light and the near-infrared light. For example, the present disclosure can be implemented also in a mode in which different image capturing optical systems form optical images respectively for an image sensor that shoots the visible light image and an image sensor that shoots the near-infrared light image.

### Sixth Modification Example

The above embodiments and modification examples have been described in relation to a mode that determines exposure settings for shooting of light in the visible light range and light in the near-infrared light range. However, the present disclosure is not limited to being embodied in this way; for example, light in another wavelength range may be used. That is to say, it is an object of the present disclosure to reduce the deviation between the influences of diffraction on images that are respectively obtained by shooting light of two types of wavelength ranges, and the present disclosure is applicable as long as there is a difference between wavelength ranges, such as a difference between representative wavelengths, for example. Therefore, in the present disclosure, in a case where a subject is shot using each of light in a first wavelength range and light in a second wavelength range that includes longer wavelengths than the first wavelength range, it is sufficient to determine a second diaphragm value that achieves a larger aperture than a first diaphragm value determined for shooting of the former as exposure settings for shooting of the latter.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-104503, filed Jun. 26, 2023, which is hereby incorporated by reference herein in its entirety.

What is claimed is:

1. An information processing apparatus that determines exposure settings of an image capturing apparatus that shoots a subject in relation to light of two types of wavelength ranges, the information processing apparatus comprising:
at least one processor or circuit configured to function as
a first obtainment unit configured to obtain a result of photometering for the subject in relation to each of light of a first wavelength range and light of a second wavelength range that includes longer wavelengths than the first wavelength range,
a first determination unit configured to, based on the result of photometering for the light of the first wavelength range, determine first exposure settings for shooting the subject in relation to the light of the first wavelength range, and
a second determination unit configured to, based on the result of photometering for the light of the second wavelength range and on the first exposure settings, determine second exposure settings for shooting the subject in relation to the light of the second wavelength range,
wherein
the exposure settings include a diaphragm value, and
the second determination unit determines a second diaphragm value for the second exposure settings, the second diaphragm value achieving a larger aperture than a first diaphragm value determined by the first determination unit.

2. The information processing apparatus according to claim 1, wherein
the second exposure settings include information of in-focus positions that are respectively used in a plurality of shots.

3. The information processing apparatus according to claim 2, wherein
the at least one processor or circuit further functions as a second obtainment unit configured to obtain a distribution of the subject in a depth direction, and
the second determination unit determines the in-focus positions of the respective plurality of shots based on a depth of field according to the second diaphragm value and on the distribution of the subject in the depth direction.

4. The information processing apparatus according to claim 3, wherein
the second determination unit determines the number of times the subject is shot in relation to the light of the second wavelength range based on the depth of field according to the second diaphragm value and on the distribution of the subject in the depth direction.

5. The information processing apparatus according to claim 3, wherein
in a case where the subject falls within the depth of field according to the second diaphragm value, the second determination unit includes information of an in-focus position used in one-time shooting, in place of the information of the in-focus positions of the respective plurality of shots, in the second exposure settings.

6. The information processing apparatus according to claim 3, wherein
in a case where the subject falls within the depth of field according to the second diaphragm value, the second determination unit includes information indicating that one-time shooting is performed instead of the plurality of shots in the second exposure settings.

7. The information processing apparatus according to claim 1, wherein
the at least one processor or circuit further functions as an evaluation unit configured to evaluate an influence of diffraction that occurs in connection with shooting, and
the second determination unit determines the second diaphragm value so that an evaluation value of the influence of diffraction for a case where the light of the second wavelength range is shot does not exceed an evaluation value of the influence of diffraction for a case where the light of the first wavelength range is shot under the first diaphragm value.

8. The information processing apparatus according to claim 7, wherein
an evaluation value of the influence of diffraction is an Airy disk diameter on an image capturing plane of an image sensor that shoots light of each wavelength range.

9. The information processing apparatus according to claim 7, wherein
the first wavelength range is a visible light range.

10. The information processing apparatus according to claim 9, wherein
the second wavelength range is a near-infrared light range.

11. The information processing apparatus according to claim 9, wherein
the second wavelength range is from 780 nm to 1000 nm.

12. The information processing apparatus according to claim 10, wherein
the evaluation unit derives an evaluation value of the influence of diffraction for a case where the light of the first wavelength range is shot based on a representative wavelength of the first wavelength range, and derives an evaluation value of the influence of diffraction for a case where the light of the second wavelength range is shot based on a representative wavelength of the second wavelength range.

13. The information processing apparatus according to claim 12, wherein
the representative wavelength of the first wavelength range is a reference wavelength in an optical device.

14. The information processing apparatus according to claim 1, wherein
the second determination unit determines a shutter speed and sensitivity of the second exposure settings based on the second diaphragm value so as to achieve appropriate exposure for the subject.

15. An image capturing apparatus, comprising:
the information processing apparatus according to claim 1;
a first image capturing device configured to shoot the subject in relation to the light of the first wavelength range;
a second image capturing device configured to shoot the subject in relation to the light of the second wavelength range; and
at least one processor or circuit configured to function as a control unit configured to cause the first image capturing device to shoot the subject based on the first exposure settings determined by the first determination unit, and cause the second image capturing device to shoot the subject based on the second exposure settings determined by the second determination unit.

16. The image capturing apparatus according to claim 15, wherein
the control unit outputs an image of the light of the first wavelength range obtained through the shooting performed by the first image capturing device, and an image of the light of the second wavelength range obtained through the shooting performed by the second image capturing device, in association with each other.

17. The image capturing apparatus according to claim 16, wherein
the at least one processor or circuit further functions as a generation unit configured to, in a case where the second image capturing device performs a plurality of shots, generate a composite image by compositing a plurality of images of the light of the second wavelength range that have been obtained through the plurality of shots, and
the control unit outputs the image of the light of the first wavelength range and the composite image in association with each other.

18. The image capturing apparatus according to claim 15, wherein
the first image capturing device and the second image capturing device are configured as one image sensor on which an image of light is formed, the light having been incident via an image capturing optical system that includes a shared diaphragm and a shared focus adjustment lens, and
the control unit causes the shooting of the first image capturing device and the shooting of the second image capturing device to be performed using a time-division method.

19. The image capturing apparatus according to claim 15, wherein
the first image capturing device and the second image capturing device are respectively configured as different image sensors on each of which an image of light is formed after the light has been dispersed, the light having been incident via an image capturing optical system that includes a shared diaphragm and a shared focus adjustment lens, and
in a case where the control unit causes the shooting of the first image capturing device and the shooting of the second image capturing device to be performed simultaneously, the first determination unit determines the first exposure settings with use of the second diaphragm value instead of the first diaphragm value.

20. A control method for an information processing apparatus that determines exposure settings of an image capturing apparatus that shoots a subject in relation to light of two types of wavelength ranges, the control method comprising:
obtaining a result of photometering for the subject in relation to each of light of a first wavelength range and light of a second wavelength range that includes longer wavelengths than the first wavelength range;
based on the result of photometering for the light of the first wavelength range, determining first exposure settings for shooting the subject in relation to the light of the first wavelength range; and
based on the result of photometering for the light of the second wavelength range and on the first exposure settings, determining second exposure settings for shooting the subject in relation to the light of the second wavelength range,
wherein
the exposure settings include a diaphragm value, and
a second diaphragm that achieves a larger aperture than a first diaphragm value determined for the first exposure settings is determined for the second exposure settings.
